(19) United States
(12) Patent Application Publication
(10) Pub. No.: US 2016/0133138 A1
(43) Pub. Date: May 12, 2016

(54) SYSTEMS AND METHODS FOR HELICOPTER SITUATIONAL AWARENESS AND LANDING ASSISTANCE

(71) Applicants: Arnold Oldach, Carefree, AZ (US); Charles Manberg, Peoria, AZ (US)

(72) Inventors: Arnold Oldach, Carefree, AZ (US); Charles Manberg, Peoria, AZ (US)

(73) Assignee: Aviation Communication & Surveillance Systems LLC, Phoenix, AZ (US)

(21) Appl. No.: 14/814,284

(22) Filed: Jul. 30, 2015

Related U.S. Application Data
(60) Provisional application No. 62/030,957, filed on Jul. 30, 2014.
(60) Provisional application No. 62/030,980, filed on Jul. 30, 2014.
(60) Provisional application No. 62/031,000, filed on Jul. 30, 2014.
(60) Provisional application No. 62/180,448, filed on Jun. 16, 2015.

(51) Int. Cl. G08G 5/02

(52) U.S. Cl. CPC G08G 5/025

(57) ABSTRACT

Systems and methods are delineated for use by a helicopter and helicopter landing stations to facilitate helicopter situational awareness and landing assistance. In accordance an exemplary embodiment, a system for use with a helicopter is delineated wherein the system comprises a ground transmitter with a GPS receiver, said ground transmitter being located in proximity to a landing pad for the helicopter; a receiver on the helicopter to receive transmissions from the ground transmitter; a display on the helicopter to depict position of the landing pad; a GPS receiver on the helicopter to provide position of the helicopter; and a database including identification information for the landing pad.

### CROSS REFERENCE TO RELATED APPLICATIONS

This application is related to and claims priority from: (1) U.S. Appl. No. 62/030,957, filed Jul. 30, 2014 and entitled “HELICOPTER PAD APPROACH SYSTEMS AND METHODS”; (2) U.S. Appl. No. 62/030,980, filed Jul. 30, 2014 and entitled “PRECISION FINAL APPROACH LANDING SYSTEMS AND METHODS”; (3) U.S. Appl. No. 62/031,000, filed Jul. 30, 2014 and entitled “HELICOPTER BUILDING SITUATIONAL AWARENESS SYSTEMS AND METHODS”; and (4) U.S. Appl. No. 62/180,448, filed Jun. 16, 2015 and entitled “SYSTEMS AND METHODS FOR COCKPIT DISPLAY OF HELIDECK INFORMATION.” Each of the foregoing applications is hereby incorporated by reference in its entirety.

### BACKGROUND OF THE INVENTION

1. Field of the Invention

The present invention relates to systems and methods for use by a helicopter, and more particularly, to systems and methods for use by a helicopter and helicopter landing stations to facilitate helicopter situational awareness and landing assistance.

2. Description of the Related Art

Today helicopters perform oil rig approaches using point-in-space standard approach procedures, such as the Offshore Standard Approach Procedure (OSAP), and utilize a Flight Management System (FMS) and a Flight Control Computer (FCC) to automatically enact the OSAP and automatically fly the helicopter to the final segment of the approach. The procedure is generated based on a surveyed waypoint defining the oil rig destination that is entered into the system and is subject to errors in the surveyed position, and therefore, errors in the waypoint that make up the approach procedure (i.e., the Initial Approach Fix (IAF), the Final Approach Fix (FAF), the Missed Approach Point (MAP), etc.).

In today's helicopter oil rig approach systems that incorporate a Flight Management System (FMS) to automatically compute the approach to the rig and couple to the Flight Control Computer (FCC) to automatically fly the approach, such systems will bring the helicopter to within ⅛ of a mile to 1 mile of the rig landing platform. From this point, the crew will manually maneuver the helicopter to the landing platform. This may present challenges to the flight crew with minimum queues in the flight deck to aid in a successful landing during low visibility conditions.

In today's helicopter flight decks, systems are available to provide the flight crew with situational awareness of the helicopter's current position relative to ground features, such as navigational aids, flight plan routings, terrain, traffic, airport surface features and obstacles on flight deck displays. This information may be invaluable to the flight crew during operations in low visibility conditions.

Thus, a need exists for systems and methods, which overcomes these and other problems.

### SUMMARY OF THE INVENTION

In accordance with the invention, an embodiment is disclosed of a system for use with a helicopter, the system comprising a ground transmitter with a GPS receiver, said ground transmitter being located in proximity to a landing pad for the helicopter; a receiver on the helicopter to receive transmissions from the ground transmitter; a display on the helicopter to depict position of the landing pad; a GPS receiver on the helicopter to provide position of the helicopter; and a database including identification information for the landing pad.

It is to be understood that both the foregoing general description and the following detailed description are exemplary and explanatory only and are not restrictive of the invention, as now or hereafter claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a system for use with helicopters, in accordance with systems and methods consistent with the present invention.

FIG. 2 is method for use with helicopters, in accordance with systems and methods consistent with the present invention.

FIG. 3 is a system for use with helicopters, in accordance with systems and methods consistent with the present invention.

FIG. 4 is method for use with helicopters, in accordance with systems and methods consistent with the present invention.

FIG. 5 is a system for use with helicopters, in accordance with systems and methods consistent with the present invention.

FIG. 6 is a view of a cockpit helideck situational awareness display, in accordance with systems and methods consistent with the present invention.

FIG. 7 is a view of a cockpit helideck situational awareness display, in accordance with systems and methods consistent with the present invention.

FIG. 8 is a system for use with helicopters, in accordance with systems and methods consistent with the present invention.

### DESCRIPTION OF THE EMBODIMENTS

Reference will now be made in detail to the present exemplary embodiments of the invention, examples of which are illustrated in the accompanying drawings.

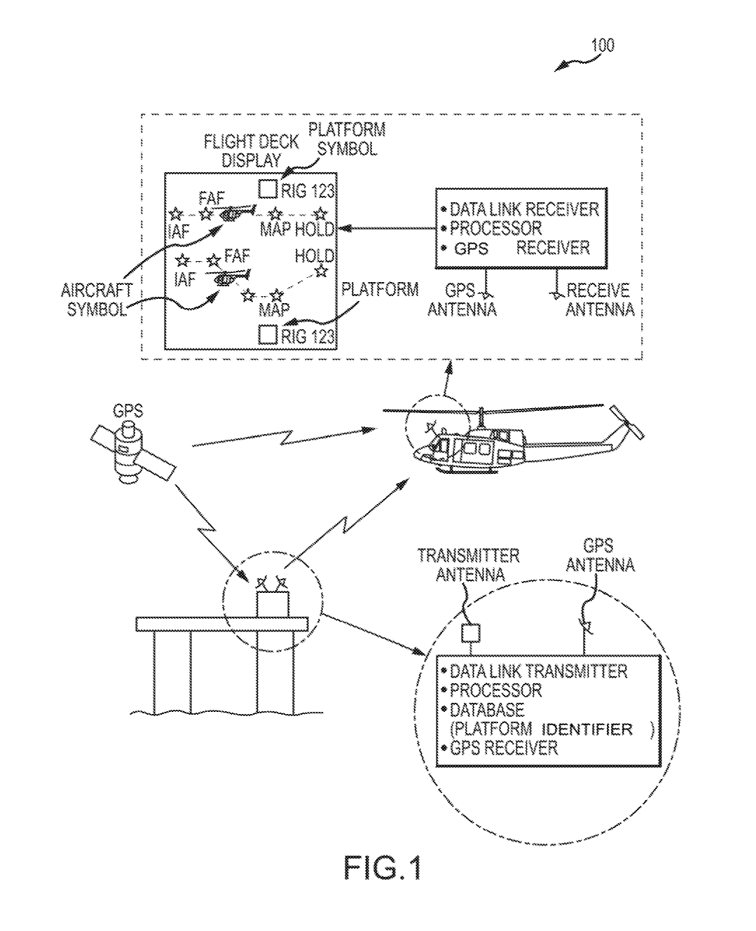

FIGS. 1 & 2

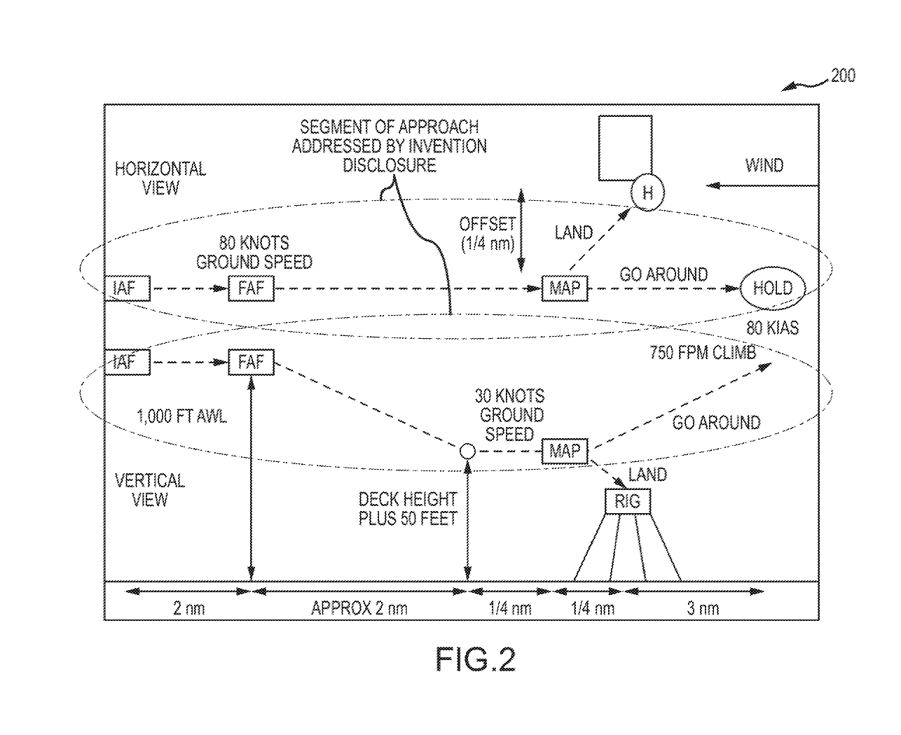

Embodiments of the present invention are depicted, by way of example, in FIG. 1 providing a system 100 of embodiments of the present invention. Embodiments of the present invention are also depicted, by way of example, in FIG. 2 providing an exemplary method 200 for an Approach Procedure addressed by embodiments of the present invention. Embodiments of the present invention could be employed to any situation where there may be a need to provide guidance along an approach procedure to a specific area (e.g., Emergency Medical Service operations, etc.).

Embodiments of the present invention may use a more accurate position source, such as GPS, to provide the destination waypoint and better definition of positions for the waypoints that define the approach procedure. The destination point GPS position may be transmitted by a data link to the helicopter as soon as it is within range of the transmitter on the oil rig and may allow the procedure flight path to be generated and either displayed to the flight crew to fly the approach procedure manually or coupled to the FCC to automatically fly the approach procedure. This alternative system can provide aircraft that cannot utilize the current systems either because of cost or capability with a lower cost and a more accurate solution.

Embodiments of the present invention may provide situational awareness guidance of the Offshore Standard Approach Procedure (OSAP) in the flight deck so the flight crew can manually fly the procedure or the system could be coupled to the FCC for automatic control. Embodiments of the present invention may utilize: (1) GPS technology to provide accurate position location of the destination point (i.e., landing pad) and aircraft, (2) a cockpit display depicting the approach procedure relative to the aircraft position, and (3) a data link (e.g., 1090 MHz or UAT ADS-B or VDL Mode 2) to transmit the accurate position of the landing pad. A database that may provide identification of the platforms could be utilized to provide a platform identifier in the transmitted information and a display in the flight deck along with the symbol depicting the landing pad relative to aircraft position. The display can provide situational awareness of one or more platforms within range of the transmitter signal from transmitting systems from those platforms.

Embodiments of the present invention may include the following:
(A) A ground transmitter with a GPS receiver to be placed at the landing pad location and transmit the GPS latitude, longitude and altitude. Other information that may be included in the transmission may include weather information, such as wind direction and velocity (from a local or other weather source).
(B) An airborne receiver to receive the transmitted positional information and a processor to process the information for display to the flight crew. The processing could also include algorithms for providing navigational queues to be displayed to the flight crew or coupled with the aircraft flight control computer for automatic maneuvering.
(C) A flight deck display to depict position of the platform and approach procedure with respect to own aircraft or guidance queues to direct the flight crew along the approach path.
(D) A GPS receiver on the aircraft to provide position of the aircraft on the display.
(E) A database with platform identification information.

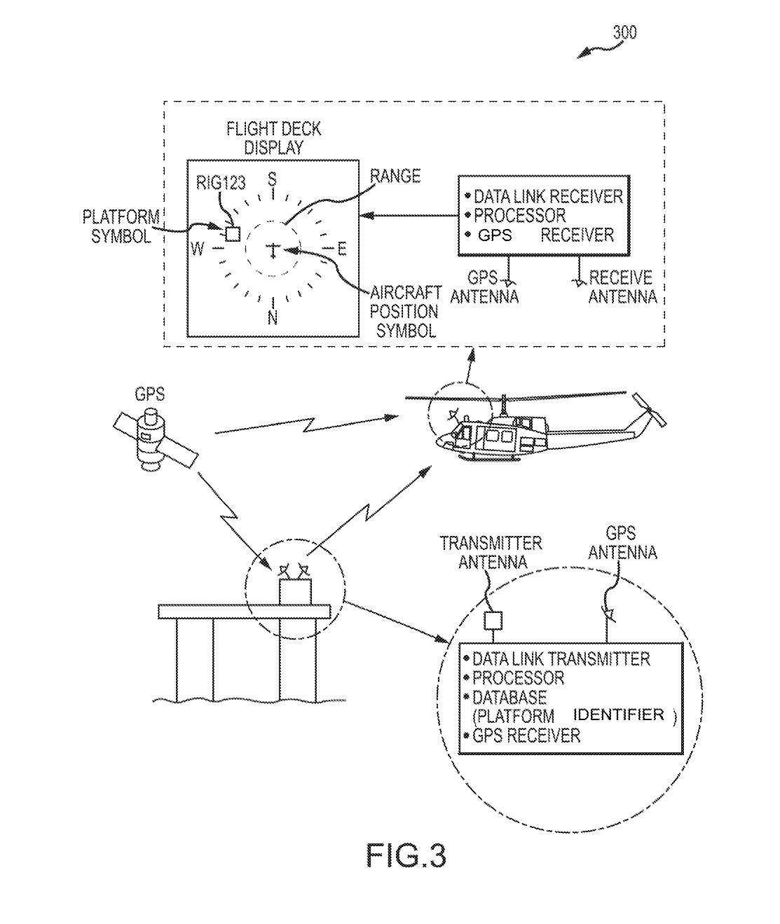

FIGS. 3 & 4

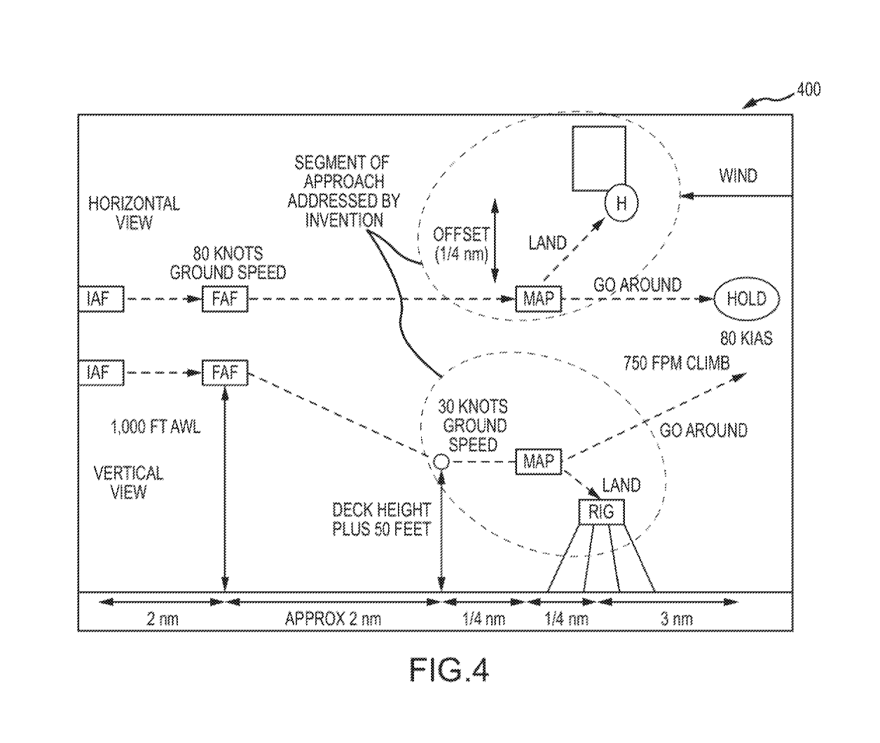

Embodiments of the present invention are depicted, by way of example, in FIG. 3 providing a system 300 of embodiments of the present invention. Embodiments of the present invention are also depicted, by way of example, in FIG. 4 providing an exemplary method 400 for an Approach Procedure addressed by embodiments of the present invention. Embodiments of the present invention could be employed with any situation where there is a need to provide situational awareness or guidance queues to a specific area (e.g., Emergency Medical Service operations, etc.)

Embodiments of the present invention may provide situational awareness in the flight deck to provide the flight crew with the location of the platform when conditions are not optimum for out-the-window sighting when maneuvering the aircraft to the platform landing pad. Embodiments of the present invention may utilize: (1) GPS technology to provide accurate position location of the landing pad and aircraft, (2) a cockpit display depicting the location of a landing pad relative to the aircraft position, and (3) a data link (e.g., 1090 MHz or UAT ADS-B or VDL Mode 2) to transmit the accurate position of the landing pad. A database that may provide identification of the platforms could be utilized to provide a platform identifier in the transmitted information and display in the flight deck along with the symbol depicting the landing pad relative to aircraft position.

Embodiments of the present invention may include:
(A) a ground transmitter with a GPS receiver that may be placed at the landing pad location and transmit the GPS latitude, longitude and altitude. Other information that may be included in the transmission may include weather information, such as wind direction and velocity (from a local or other weather source).
(B) an airborne receiver to receive the transmitted positional information and a processor to process the information for display to the flight crew. The processing could also include algorithms for providing navigational queues to be displayed to the flight crew or coupled with the aircraft flight control computer for automatic maneuvering.
(C) a flight deck display to depict position of the platform with respect to own aircraft or guidance queues to direct the flight crew to the landing pad.
(D) a GPS receiver on the aircraft to provide position of the aircraft on the display.
(E) a database with platform identification information.

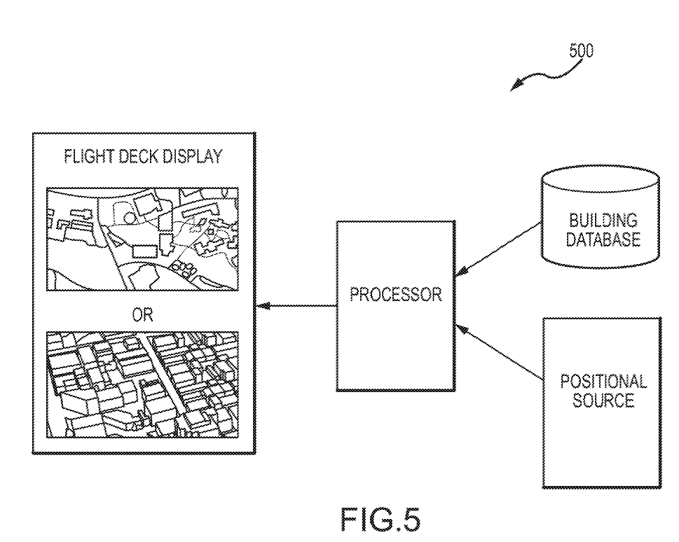

FIG. 5

Embodiments of the present invention are depicted, by way of example, in FIG. 5 providing a system 500 in accordance with embodiments of the present invention.

Additional situational awareness information of potential interest may be the location of buildings for helicopter operations within city municipalities (e.g., for helipad landing on buildings, emergency medical services, etc.). Knowledge of the location of buildings or landmarks on a flight display may give the flight crew relative positioning situational awareness of the aircraft with these displayed objects. This situational awareness may be similar to a Google Map display provided on a phone or a tablet device, but displayed on a flight deck display.

Embodiments of the present invention may utilize: (1) a positional information source, such as a GPS device, to accurately provide position of the aircraft, (2) a flight deck display that may depict the location of buildings/landmarks relative to the aircraft position either in a top down view or 3-D view, (3) a database that may provide coordinates and attributes of the building/landmarks used in the display of these features on the flight deck display, (4) and a processor to process the inputs, create the displayed information, and provide information to the display.

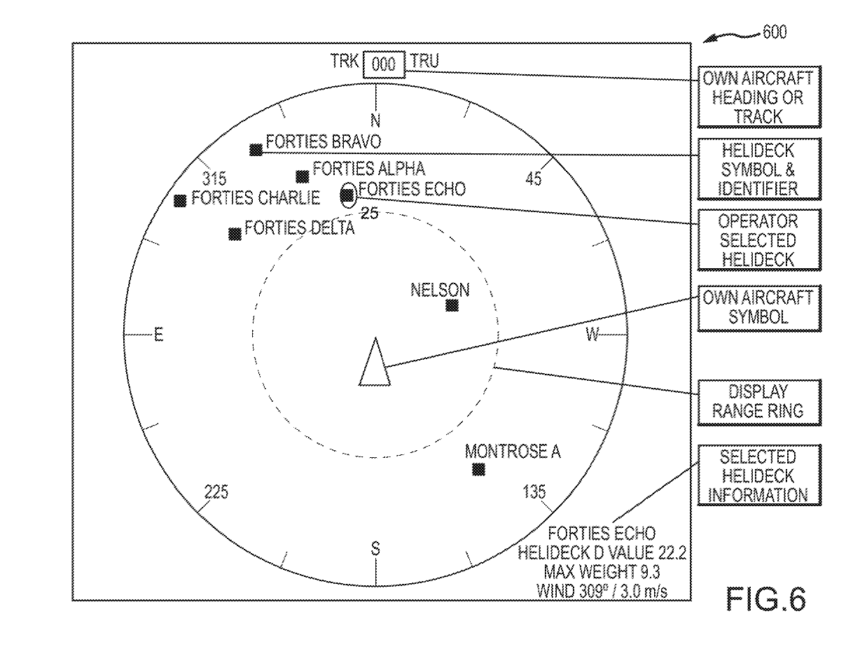

FIGS. 6-8

Today's helicopter land-based/off-shore landing and departure operations during adverse conditions, such as low visibility, darkness, glare, rough seas and the like, is a hazardous task. During approach and take-off, flight crews need to choose a flight path clear of obstacles and hazards associated with the helideck, as well as judge via out-the-window visual check of the helideck the height above the helideck. For moving offshore helidecks, determining helideck stability to choose the moment to land/depart is important for landings and departures operations to reduce the risk of potential accidents posed by moving helidecks (i.e., unpredictable rotor disc movement injuring personnel nearby, vehicle rollover, etc.).

There are very few reference and decision cues provided on a flight deck display to aid the flight crew's out-the-window visual acquisition of the surrounding helideck environment for improving orientation and situational awareness, while aiding safe and effective operations under adverse conditions. Embodiments of the present invention may serve to, among other things, provide cues on a flight deck display to aid the flight crew's visual acquisition of the surrounding helideck environment, such cues including, without limitation, one or more of a distance to the helideck, a height above the helideck, indication of helideck motion, indication of obstacles, or any other desired indication. Also, there is no situational awareness of helideck location during helicopter en route operations to aid performing an approach to the intended helideck, as well as identifying potential landing sites during emergency landing situations.

Embodiments of the present invention may provide the helicopter flight crew with a situational awareness display on a tablet, a flight deck or other display depicting information about the helideck and surrounding surface features (e.g., other buildings or the like for land based helidecks) to aid the flight crew's in (1) identifying the location and type of helideck in the surrounding area and (2) out-the-window visual observation when local conditions are not optimum for maneuvering the aircraft to/from the helideck. The helideck situational awareness display is intended but not limited to use with aircraft operating over metropolitan areas, helidecks on buildings (e.g. hospitals, corporate buildings, etc.), off shore helidecks (both fixed and moving—ships, drilling ships, yachts, barges, etc.), and search and rescue or emergency base operations. The helideck situational display may provide the following information and capability to provide the flight crew with visual cues, alerts and decision making enhancements:
A. Helideck location relative to own aircraft position and heading/track (i.e., range, bearing, elevation separation and the like).
B. Helidecks proximity to each other.
C. Range control to allow the flight crew to zoom in or out providing greater or less detail of the helideck and the surrounding areas.
D. Helideck selection control to allow the flight crew to select a specific helideck.
E. Graphical moving map display of the helideck surface layout and features relative to own aircraft position and heading/track.
F. Helideck facility information such as name, asset owner, facility latitude/longitude, currently active NOTAMS (i.e., Notices to Airmen), weather information, etc.
G. Helideck information, such as elevation, landing area details, such as maximum allowable weight, helicopter size limitations, contact numbers, weather station reporting capability and the like.
H. Helideck map features, such as surface layout and dimensions, prohibited landing areas, design of approach/departure and obstacle-free zones and take-off area identification, location of helideck access and egress stairways and ladders, helideck fire protection capability, helideck safety equipment, including tie-down points and ropes, helideck lighting and marking types/configuration, wind direction indicators, positioning of aviation fueling stations on fixed or other platforms, obstacle-free sector identification, cold weather helideck precautions, thermal area identification, plus any other relevant or otherwise desired map features.
I. Indication of aircraft height relative to helideck height/elevation (indications could be audible and/or visual).
J. Helideck current local environmental (e.g., gas plumes, high temperature exhaust plumes, gas burn off, release of process gas, wind flow around the platform, turbulence and other environmental conditions caused by other than meteorological conditions) and meteorological information (e.g., wind speed, wind direction, gust speed, etc.), including trend data either calculated on the aircraft or provided via the Helideck Surveillance Transceiver.
K. Helideck current motion data (i.e. pitch, roll, heave, etc.) including Go/No Go Landing Indication based on helideck motion information and motion trend data either calculated on the aircraft or provided via the Helideck Surveillance Transceiver (all applicable for moving helidecks but could be employed with fixed helidecks as well).
L. Automatic selection of helideck(s) capable of accommodating a helicopter during an emergency forced landing situation and display of one or more flight paths to the selected helideck (i.e., direct line between own aircraft and helideck along with bearing indication to helideck). May provide location of helidecks within range and their attributes and suppress display of those helidecks that do not provide a good match for the weight, performance characteristics, and/or weather conditions for the aircraft and helideck.

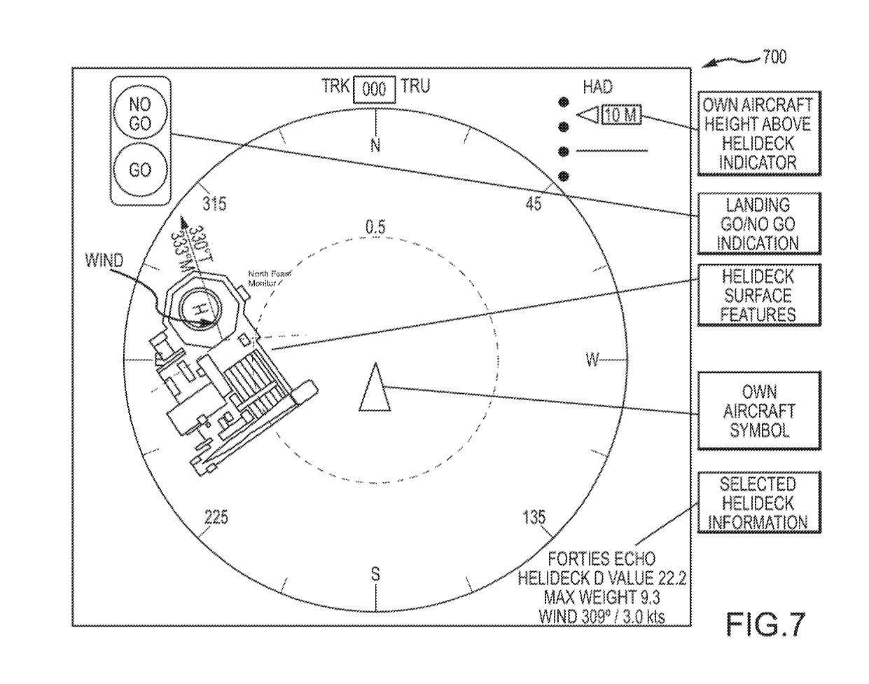

FIGS. 6 and 7 provide exemplary views of cockpit helideck situational awareness displays 600 and 700, respectively, in accordance with embodiments of systems and methods consistent with the present invention.

Embodiments of the present invention may utilize (1) a cockpit display depicting the helideck situational awareness information described herein, (2) a highly accurate position source (e.g., GPS technology or any other desired source of position information) to provide accurate position information for the helideck and aircraft, (3) a data link (e.g., any point-to-point or broadcast medium including but not limited to 1090 MHZ/1090 MHz Phase Enhancement¹, cellular, Wifi/WiMAX/AeroMACS, VDL Mode 2, VDL Mode 4, or 978 MHz UAT, etc.) to transmit helideck position and/or other information describing the helideck information and environmental conditions, (4) one or more databases that may contain helideck and/or operator customizable information used to provide flight deck helideck layout and surface feature situational awareness on a cockpit display device, (5) and processing capability both in the ground and airborne systems to interface, store, and process the data. ¹Phase Enhancement (sometimes alternatively referred to as “ATC-Data Overlay”) is a term referencing ACSS technology variously described in the following patent applications and patents, hereby incorporated herein by reference: Appl. No. 60/926,126, filed Apr. 24, 2007; application Ser. No. 12/105,248, filed Apr. 17, 2008; Appl. No. 60/931,274, filed May 21, 2007; Appl. No. 61/054,029, filed May 16, 2008; Appl. No. 61/059,736, filed Jun. 6, 2008; Appl. No. 61/060,385, filed Jun. 10, 2008; Appl. No. 61/163,747, filed Mar. 26, 2009; Appl. No. 61/176,046, filed May 6, 2009; application Ser. No. 12/467,997, filed May 18, 2009 (now U.S. Pat. No. 8,344,936); application Ser. No. 12/482,431, filed Jun. 10, 2009 (now U.S. Pat. No. 8,031,105); application Ser. No. 12/455,886, filed Jun. 8, 2009; Appl. No. 61/253,981, filed Oct. 22, 2009; application Ser. No. 12/748,351, filed Mar. 26, 2010; application Ser. No. 12/775,321, filed May 6, 2010; application Ser. No. 12/910,642, filed Oct. 22, 2010; Appl. No. 61/845,864, filed Jul. 12, 2013 and application Ser. No. 14/331,089, filed Jul. 14, 2014.

Embodiments of the present invention may comprise one or more of the following:
A. Helideck Surveillance Transceiver System that may incorporate a highly accurate position source that may be placed at the landing pad location and broadcast the helideck characteristics, such as the platform name, the center of the helideck latitude and longitude, elevation, dimensions, the local current time stamped, the weather conditions (e.g., reporting station identification, current time, wind direction and speed, gust speed, temperature, cloud height, icing conditions, typical meteorological report content and the like), helideck dynamic motion information (e.g., pitch, roll, heave, motion severity index, wind severity index, wind/gust/motion trend information and the like), manual entry of current conditions of interest to flight crews similar to ATIS/NOTAMS, etc. The Helideck Surveillance Transceiver System may provide the interfaces to external systems to acquire broadcast data (e.g., weather data, helideck motion data, etc.), a processor and memory capability to access helideck information, compute trend information (e.g., gust trends, ceiling/visibility trends, and motion indexes), and format data for broadcast, and a data link capability to broadcast the helideck parameters.
B. Airborne Processor, memory and a data link to receive the transmitted helideck information described in (A) above and process the information for the helideck situational awareness display for the flight crew. The Airborne Processor may include algorithms for providing navigational cues to be displayed to the flight crew or employed by the aircraft flight control computer (or other system) for automatic maneuvering. The Airborne Processor may include interfaces to the flight deck display and memory storage for the Helideck Database described in (E) below.
C. Flight Deck Display and Controls to depict the situational awareness information described herein.
D. A highly accurate position sensor (e.g. a GPS receiver or the like) on the aircraft or included in the Airborne Processor to provide position of the aircraft on the display.
E. Helideck Database with helideck information and characteristics (e.g., information found on a Helideck Information Plate, such as facility name, company, helideck height, obstacle indications/locations, latitude/longitude, surface layout, dimension, landing area details, communication frequency, D value (helideck diameter of the largest helicopter the helideck can serve), perimeter D markings, perimeter line markings, touchdown/positioning marking circle, helideck identification marking, landing on installation/vessel prohibited, prohibited landing heading marking, etc.).

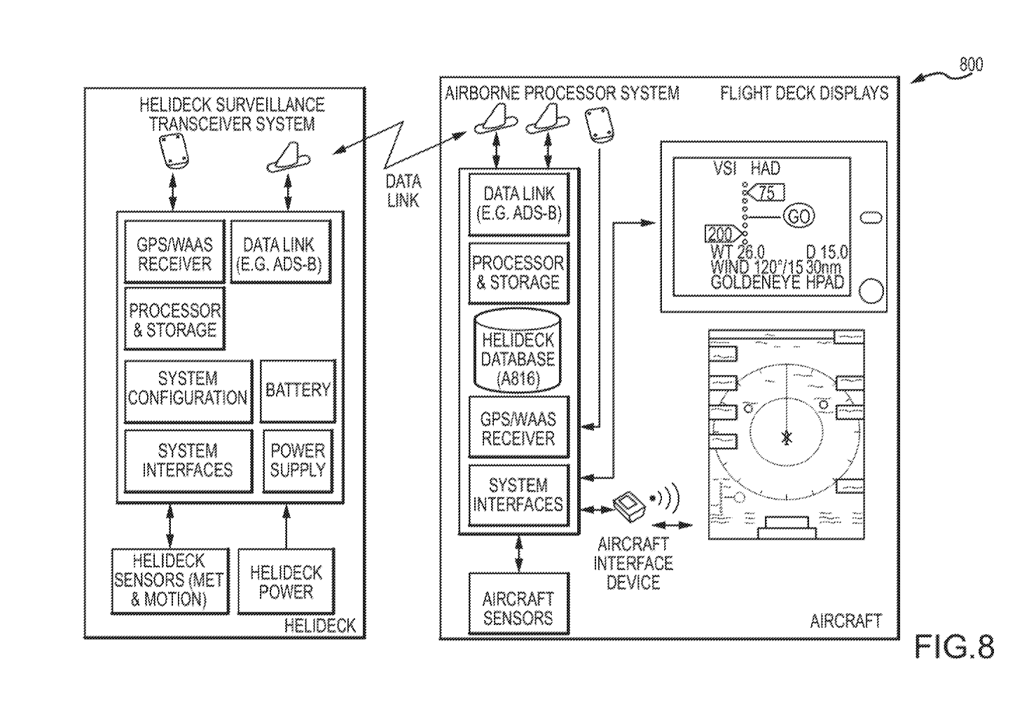

FIG. 8 provides an exemplary system 800 in accordance with embodiments of the present invention:

Embodiments of the present invention could apply to any situation where there is a need to provide situational awareness or guidance cues to one or more specific locations to support operations such as Search and Rescue (SAR) where identification of operation staging locations and characteristics may be provided to the flight crews.

Embodiments of the present inventions' helideck flight deck situational awareness display could also provide a 3D rendering of the helideck platforms or any other desired structure.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims, as presently filed or subsequently supplemented.

What is claimed is:

1. A system for use with a helicopter, the system comprising:
a ground transmitter with a GPS receiver, said ground transmitter being located in proximity to a landing pad for the helicopter;
a receiver on the helicopter to receive transmissions from the ground transmitter;
a display on the helicopter to depict position of the landing pad;
a GPS receiver on the helicopter to provide position of the helicopter; and
a database including identification information for the landing pad.
